(19) United States
(12) Patent Application Publication
(10) Pub. No.: US 2025/0158372 A1
(43) Pub. Date: May 15, 2025

(54) MULTICORE RIGID BUSBAR FOR ELECTRIC POWER DISTRIBUTION

(71) Applicant: Tesla, Inc., Austin, TX (US)

(72) Inventors: Whitney Mathews, Mountain View, CA (US); Neil Prasad, Mountain View, CA (US)

(21) Appl. No.: 18/837,432

(22) PCT Filed: Feb. 16, 2023
(86) PCT No.: PCT/US2023/013250

§ 371 Date: Aug. 9, 2024

Related U.S. Application Data
(60) Provisional application No. 63/311,778, filed on Feb. 18, 2022.

(51) Int. Cl. H02G 5/00; B60R 16/02; B60R 16/033; H01B 7/02

(52) U.S. Cl. CPC H02G 5/00; B60R 16/0207; B60R 16/033; H01B 7/02

(57) ABSTRACT

Aspects of this disclosure relate to a multi core rigid busbar (100) that includes a plurality of rigid conductors (206) and insulator (202) around the plurality of rigid conductors. Each conductor of the plurality of rigid conductors can carry current between electrical components, such as between load and source ends. In certain embodiments, each end of the multicore rigid bus bar can be directly plugged into an electrical terminal of the electrical component without connector.

### CROSS-REFERENCE TO PRIORITY APPLICATION

This application claims the benefit of priority of U.S. Provisional Application No. 63/311,778, filed Feb. 18, 2022, and titled “Connectorless Multicore Rigid Busbar For Electric Power Distribution,” the disclosure of which is hereby incorporated by reference in its entirety and for all purposes.

### BACKGROUND

### Technical Field

The disclosed technology relates to electric power distribution.

### Description of Related Technology

A vehicle power distribution system can utilize harnesses with flexible braided cables, with or without connectors, to carry current. A connector typically includes a housing that positions an electrical terminal connected to the end of the cable. The connection between the terminal and cable is an electrical joint and is typically formed by bolt, weld, crimping, or any suitable electrical connection. These cables can distribute power between the electric components of a vehicle. These cable assemblies (harnesses) are typically flexible and typically require parts, such as brackets, fastening materials, or housing units for in-vehicle routing and mounting. As the need for the vehicle's power distribution paths increases, using flexible braided cables with connectors can present technical challenges.

### SUMMARY OF CERTAIN INVENTIVE ASPECTS

The innovations described in the claims each have several aspects, no single one of which is solely responsible for its desirable attributes. Without limiting the scope of the claims, some prominent features of this disclosure will now be briefly described.

One aspect of this disclosure is a multicore rigid busbar. The multicore rigid busbar includes a plurality of rigid conductors configured to carry current between components and an insulator around the plurality of rigid conductors.

In the multicore rigid busbar, an end of at least one of the rigid conductors can be configured to directly connect to an electrical terminal.

In the multicore rigid busbar, the rigid conductors may include at least one of aluminum or copper.

In the multicore rigid busbar, the insulator may include at least one of cross-linked polyethylene (XLPE), polyvinyl chloride (PVC), nylon, silicone, thermoplastic, or thermoset plastic.

In the multicore rigid busbar, the rigid conductor at the source end can be directly connectable to a battery pack. At least one of the rigid conductors can also be directly connectable to an electrical terminal on a printed circuit board assembly.

In the multicore rigid busbar, the multicore rigid busbar may include a shielding layer surrounding the insulator. The shielding layer can be electrically conductive.

In the multicore rigid busbar, the multicore rigid busbar can be bent to conform to in-vehicle packaging and to extend between a vehicle battery pack and one or more electrical components.

In the multicore rigid busbar, the multicore rigid busbar can be shaped to conform to in-vehicle packaging and to extend between multiple electrical components.

In the multicore rigid busbar, the multicore rigid busbar may include a groove located between rigid conductors of the plurality of rigid conductors.

In the multicore rigid busbar, the multicore rigid busbar may include a locking hole in a body of the multicore rigid busbar. The locking hole can be configured to receive a locking piece.

In the multicore rigid busbar, the multicore rigid busbar can be symmetrically bent. The ends of the conductor may have substantially the same length from cutting.

A vehicle may include the multicore rigid busbar.

Another aspect of this disclosure is an electrical connection system. The electrical connection system includes a plurality of rigid conductors within a single outer sheathing, and an insulation layer around the plurality of rigid conductors. The plurality of rigid conductors is configured to at least carry current from a source to a load. At least one of the plurality of rigid conductors is configured to directly connect to an electrical terminal.

In the electrical connection system, the system may also include a shielding layer around the insulation layer.

In the electrical connection system, at least one of the plurality of rigid conductors is configured to directly connect to an electrical terminal.

For purposes of summarizing the disclosure, certain aspects, advantages and novel features of the innovations have been described herein. It is to be understood that not necessarily all such advantages may be achieved in accordance with any particular embodiment. Thus, the innovations may be embodied or carried out in a manner that achieves or optimizes one advantage or group of advantages as taught herein without necessarily achieving other advantages as may be taught or suggested herein.

### BRIEF DESCRIPTION OF THE DRAWINGS

Embodiments of this disclosure will be described, by way of non-limiting examples, with reference to the accompanying drawings.

FIG. 1A depicts a connectorless multicore rigid busbar.

FIG. 1B depicts an example of a braided harness assembly, including various connectors.

FIG. 2A depicts one end of a connectorless multicore rigid busbar.

FIGS. 2B, 2C, and 2D depict cross-sectional views of various embodiments of a connectorless multicore rigid busbar.

FIGS. 2E and 2F depict embodiments of a connectorless multicore rigid busbar having a rectangular shape.

FIGS. 3A and 3B depict one end of a connectorless multicore rigid busbar having a groove and an additional part that interfaces with the groove to provide high voltage creepage and clearance isolation.

FIG. 4A depicts one end of a connectorless multicore rigid busbar plugging into a printed circuit board assembly (PCBA).

FIG. 4B depicts one side of the PCBA of FIG. 4A.

FIG. 4C depicts another side of the PCBA of FIG. 4B.

FIG. 4D depicts one end of a connectorless multicore rigid busbar after plugging into the PCBA.

FIG. 4E depicts an example assembly of the connectorless multicore rigid busbar and a PCBA.

FIG. 4F depicts the connectorless multicore rigid busbar and the PCBA of FIG. 4E after assembly.

FIG. 4G depicts an example assembly of a connectorless multicore rigid busbar and a header assembly.

FIG. 4H depicts the connectorless multicore rigid busbar and the header assembly of FIG. 4E after assembly.

FIG. 5A illustrates a rectangular shape connectorless multicore rigid busbar with grooves at the ends for providing electrical isolation, where the connectorless multicore rigid busbar is bent to conform to vehicle packaging specifications.

FIG. 5B depicts one end of the rectangular connectorless multicore rigid busbar of FIG. 5A, where a groove is added for mating with an additional part to increase an electrical isolation distance between conductors.

FIG. 6A illustrates a rectangular connectorless multicore rigid busbar with a locking hole to set position of the busbar and prevent electrical contact fretting.

FIG. 6B illustrates a rectangular connectorless multicore rigid busbar with a locking hole, a surrounding assembly, and a vehicle assembly to set position of the busbar and prevent electrical contact fretting.

FIG. 6C illustrates a rectangular connectorless multicore rigid busbar with a locking hole and a surrounding assembly to set position of the busbar and prevent electrical contact fretting.

FIG. 6D illustrates a rectangular connectorless multicore rigid busbar assembled with the surrounding assembly and a printed circuit board assembly (PCBA).

FIG. 6E illustrates an example embodiment of the connectorless multicore rigid busbar assembled with a printed circuit board assembly (PCBA).

FIGS. 7A and 7B depict a bent rectangular connectorless multicore rigid busbar with uneven rigid conductors at load end, where the connectorless multicore rigid busbar is bent to conform to vehicle packaging specifications.

FIG. 7C depicts a symmetrically bent rectangular connectorless multicore rigid busbar.

FIGS. 8 to 15 illustrate example cross-sectional schematic views of embodiments of connectorless multicore rigid busbars with various conductor sizes, cross-sectional shapes, patterns, and materials.

FIG. 8 illustrates a cross-sectional view of a connectorless multicore rigid busbar with hollow portions within conductors according to an embodiment.

FIG. 9 illustrates a cross-sectional view of a connectorless multicore rigid busbar with conductors and grooves between conductors in end portions according to an embodiment.

FIG. 10 illustrates a cross-sectional view of a connectorless multicore rigid busbar with conductors and without grooves to an embodiment.

FIG. 11 illustrates a cross-sectional view of a connectorless multicore rigid busbar with hollow portions within conductors and without grooves according to an embodiment.

FIG. 12 illustrates a cross-sectional view of a connectorless multicore rigid busbar with two conductors according to an embodiment.

FIG. 13 illustrates a cross-sectional view of a connectorless multicore rigid busbar with conductors having different sizes according to an embodiment.

FIG. 14 illustrates a cross-sectional view of a connectorless multicore rigid busbar with hollow portions within two conductors according to an embodiment.

FIG. 15 illustrates a cross-sectional view of a connectorless multicore rigid busbar with another conductor arrangement according to an embodiment.

### DETAILED DESCRIPTION OF CERTAIN EMBODIMENTS

The following detailed description of certain embodiments presents various descriptions of specific embodiments. However, the innovations described herein can be embodied in a multitude of different ways, for example, as defined and covered by the claims. This description makes reference to the drawings where reference numerals can indicate identical or functionally similar elements. It will be understood that elements illustrated in the figures are not necessarily drawn to scale. Moreover, it will be understood that certain embodiments can include more elements than illustrated in a drawing and/or a subset of the illustrated elements. Further, some embodiments can incorporate any suitable combination of features from two or more drawings.

As discussed above, flexible braided cables for distributing electricity between electrical components can encounter technical challenges. More specifically, as demand for a number of electrical components and power specification increase in the same or smaller form factor of an electrical components package, an effective electrical power distribution system that can distribute power to the electrical components in various power specifications is desired. For example, in a vehicle power distribution system that involves electricity distribution between electrical components within the vehicle, distributing electricity can encounter technical challenges as the demand for vehicle electrical components and the power specifications increase.

As vehicle technology advances, more electrical components and electrical pathways are included in the vehicle. These electrical pathways are typically power distribution paths from a battery pack to each electrical component. For example, one or more electrical components can be connected to the battery pack through a flexible harness, including multiple cables, where the battery pack distributes the power through the cable. Thus, more flexible braided cables are desirable to connect each electrical component. However, the flexible braided cable assembly process can carry relatively high assembly costs and vehicle packaging constraints. Typically, assembling a flexible harness involves assembling parts such as multiple brackets, fastening materials, cables, connectors, clips, tape, connector seals, and housing. Cable manufacturing can also be process intensive and expensive. Thus, assembling the harnesses in the vehicle power distribution system may not be cost-effective. Furthermore, since a relatively large number of flexible braided cables can be assembled within the vehicle to interconnect the electrical components, packaging the flexible braided cables within the vehicle can be challenging. Therefore, assembling the flexible braided cable can cause electrical vehicle packaging constraints.

Embodiments of this disclosure relate to a connectorless multicore rigid busbar for a power distribution system. The connectorless multicore rigid busbar can distribute power between a power source to one or more electrical components without using a connector. Without using the connector, the connectorless multicore rigid busbars disclosed herein can plug directly into an electrical socket or an electrical joint. The conductor cores of such busbars can function as both the path to carry current and the end electrical terminals of the busbar. For example, the conductor cores can be connected between components to carry a current, where each end of the conductor cores is directly connected to an electrical terminal of a respective component. The connectorless multicore rigid busbar can include a plurality of rigid conductors within a single outer sheathing or part. Such an outer sheathing or part can provide a protective covering or casing for the plurality of rigid conductors.

The connectorless multicore rigid busbar can distribute power within a vehicle, such as an electric vehicle. In some embodiments, for example, the connectorless multicore rigid busbar can electrically connect a battery pack of the vehicle and electrical components within the vehicle. The connectorless multicore rigid busbar can carry relatively low or relatively high power in certain applications. The connectorless multicore rigid busbar can include shielding. The connectorless multicore rigid busbar can transfer a relatively high or relatively low electric power from a source to a load. The source can include any suitable power source that provides electrical power to one or more electrical components in the vehicle, such as a battery pack or alternating current (AC) generator. In some embodiments, the connectorless multicore rigid busbar distributes electrical power from the battery pack to one or more electrical components in the vehicle. For example, the connectorless multicore rigid busbar can distribute electrical power from the battery pack to one or more of a vehicle's electrical power conversion system (PCS), drive units, heating ventilation and air conditions (HVAC) system, battery management system, onboard computer, etc. In some such applications, a connectorless multicore rigid busbar may run from the battery pack to the front and/or rear drive units. In an embodiment, the battery pack, PCS, and drive units are connected through a connectorless multicore rigid busbar. In some embodiments, the connectorless multicore rigid busbar distributes AC, direct current (DC) power, and/or a combination of AC and DC power. In such embodiments, the connectorless multicore rigid busbar can replace traditional wire harness assemblies within one or more of a battery pack and/or harness assemblies within DC heat pump compressor, AC charging, or AC outlet harnessing. The connectorless multicore rigid busbar can support low voltage, high voltage, a low current, high current, or any suitable combination thereof.

Compared to traditional flexible braided harnesses, connectorless multicore rigid busbars disclosed herein can provide at least an order of magnitude increase in system capability in the same packaging volume. For example, the connectorless multicore rigid busbars utilizes a solid conductor as an electrical pathway. However, the traditional flexible braided harnesses utilize a stranded cable (e.g., formed by braided stranded wires) as the electrical pathway. The overall diameter of the conductor in the connectorless multicore rigid busbar can be smaller than the overall diameter of the stranded cables in distributing electrical power. Thus, when distributing the same amount of electric power, the connectorless multicore rigid busbar can provide a smaller form factor than the flexible braided harness. For example, the connectorless multicore rigid busbar has a solid cross-section area of the conductor, where the solid cross-section area corresponds to the overall diameter of the connectorless multicore rigid busbar. However, the overall diameter of the traditional flexible braided harnesses includes the overall diameters of each wire in the stranded cable. In the stranded cable, the braided wires have an air gap between each other. In addition, while the conductor in the connectorless multicore rigid busbar includes a single insulating layer that covers the outer area of the conductor, each cable in traditional flexible braided harnesses includes an insulation layer that covers the outer area of each cable. Thus, the stranded cable may include multiple insulation layers between adjacent cables. Thus, the cross-section area of the conductor (e.g., the overall diameter of the connectorless multicore rigid busbar) in the connectorless multicore rigid busbars can be larger than the cross-section area of the conductor (e.g., conductor included in each cable) in a traditional flexible braided harness in the same volume. Therefore, the connectorless multicore rigid busbar can transfer higher power than the traditional flexible braided harnesses in the same overall diameter.

Rigid conductors within the connectorless multicore rigid busbar can provide multiple electrical pathways replacing multiple traditional flexible braided cables. The rigid conductors within the connectorless multicore rigid busbar can provide an electrical connection between components without using a connector at either end of the connectorless multicore rigid busbar. For example, a connectorless multicore rigid busbar may connect a battery pack and an electrical component. One end of the conductor of the connectorless multicore rigid busbar can be directly connected to the battery's terminal, and the other end of the conductor can be directly connected to the electrical component. Thus, the number of electrical joints with the connectorless multicore rigid busbar can be reduced compared to the traditional flexible braided cables that involve connectors at either end of the cables.

The rigid conductors within the connectorless multicore rigid busbar can be a solid conductor cross-section, while traditional braided cables are comprised of many stranded wires. The rigid conductor within the connectorless multicore rigid busbar is an electrical pathway. For example, a connectorless multicore rigid busbar may distribute power from the battery pack to more than one electrical component within the vehicle, such as an electric vehicle.

Connectorless multicore rigid busbars disclosed herein can reduce a number of electrical joints and electrical connection parts, such as terminals typically found in flexible braided cable systems. Conductors of the connectorless multicore rigid busbars can advantageously form the end-to-end of the current distribution path as well as the mating electrical joint, whereas traditional cables typically require additional terminals to be joined to the ends to form mating connections. In certain applications, one or more end conductors of a connectorless multicore rigid busbar can be plated based on electrical joint specifications. According to some other applications, one or more end conductors of a connectorless multicore rigid busbar are unplated based on electrical joint specifications. In addition, since the conductor in the connectorless multicore rigid busbar is rigid (e.g., a solid conductor), it is geometrically similar to a pin that may be crimped onto the stranded flexible cable to form a rigid surface for an electrical connection. Therefore, this crimped connection can be deleted in the connectorless multicore rigid busbar. Thus, the number of electrical joints can be reduced by using the rigid busbar as the electrical interface itself.

Connectorless multicore rigid busbars disclosed herein can reduce the number of seals. If sealing is desired, a single seal can interface on the outside of the insulation layer or shielding layer of a connectorless multicore rigid busbar. Advantageously, reducing the number of seals can be cost effective and/or increase the reliability of the connectorless multicore rigid busbars. In traditional connectors, each individual cable has a wire seal through the end termination or connector interface. Thus, such traditional connectors seal against the connector housing and also involve seals for the plug to header interface. Traditional connectors also typically include a seal for the connector plug to header interface.

Assembling the connectorless multicore rigid busbar can be cost-effective. This can be due to removing the end connector assembly used in the conventional connector, which often includes electrical terminals, locking parts, seals, and housings. The connectorless multicore rigid busbar can be directly connected to an electrical interface. For example, rigid conductors at the ends of the connectorless multicore rigid busbar can be directly connected to a printed circuit board assembly (PCBA) of an electrical component. Thus, the connectorless multicore rigid busbar can be implemented without any connector assembly. Accordingly, an electric power distribution system that includes the connectorless multicore rigid busbar can be assembled without a processing step to assemble the connector unit.

Traditional cable manufacturing is labor intensive, adding high processing costs and poor tolerance compared to typical machine operations. Cable processing, electrical terminal connection, and connector assembly also have many parts, processing steps, and expensive equipment. Furthermore, additional brackets and fastening materials are added to flexible cable assemblies to tie the cables together or provide rigidity and mounting points to conform to in-vehicle packaging.

The connectorless multicore rigid busbar can provide rigidity to conform to vehicle packaging. The connectorless multicore rigid busbar can include a solid conductive metal, such as aluminum or copper. Moreover, the connectorless multicore rigid busbar can be shaped by bending the busbar to be assembled on or near the vehicle's aperture.

In some embodiments, the connectorless multicore rigid busbar comprises multiple rigid conductors and an electrical insulator. In these embodiments, the electrical insulator surrounds each of the rigid conductors. The material for a rigid conductor can include any suitable conductive material, such as aluminum, copper, bronze, brass, gold, silver, the like, or any suitable combination or alloy thereof. The material for the electrical insulator can include any suitable insulation material, such as cross-linked polyethylene (XLPE), polyvinyl chloride (PVC), silicone, or plastic.

In embodiments disclosed herein, electrical power is distributed through the connectorless multicore rigid busbar. The rigid conductors within the connectorless multicore rigid busbar distribute the electrical power. During the electrical power distribution, one end of the rigid conductors can be connected to a power source such as a battery pack. Another end of the rigid conductors can be connected to a load, such as the electric components of the vehicle.

In some embodiments, a connectorless multicore rigid busbar distributes power from a source, such as a battery pack, to multiple loads, such as electric components within a vehicle. The connectorless multicore rigid busbar can extend from a source to one or more loads. In these embodiments, multiple pairs of rigid conductors at one end of a connectorless multicore rigid busbar are connected to corresponding terminals, such as mating electrical joints, for example, within the battery pack. Each pair of the rigid conductors at another end of the connectorless multicore rigid busbar can be connected to an electrical component. For example, the connectorless multicore rigid busbar can include three pairs of rigid conductors (six rigid conductors). One end of the three pairs of the rigid conductors can be connected to a battery pack with three electrical plugs. Each pair of the rigid conductors at another end of the rigid conductors can be connected to one of a drive unit, a heat pump, and a PCS unit. Thus, a connectorless multicore rigid busbar having six rigid conductors can distribute power to three electrical components.

In some embodiments, a connectorless multicore rigid busbar can electrically connect multiple electrical components. In these embodiments, the connectorless multicore rigid busbar includes multiple pairs of rigid conductors. A pair of the rigid conductor at one end of the connectorless multicore rigid busbar can be connected to an electrical component. Another end of a pair of the rigid conductor can be connected to another electrical component. For example, the connectorless multicore rigid busbar has two pairs of rigid conductors. A first pair of the rigid conductors can connect ECU and drive unit. A second pair of the rigid conductors can connect the braking system and a battery. Thus, a single connectorless multicore rigid busbar can electrically connect four electrical components.

Rigid conductors of the connectorless multicore rigid busbar can be surrounded by a shielding layer. The shielding layer provides a shield for electromagnetic interference (EMI) and protection from damage. The shielding layer may be flexible or rigid. The shielding layer can be made of any suitable EMI shielding material, such as aluminum, electrically conductive plastic, carbon fiber, stainless fiber, etc. In some embodiments, the shielding layer may be grounded to the vehicle's Body in White (BIW). This can provide an isolation loss detection in the event of a high voltage short circuit. The connectorless multicore rigid busbar can include a shielding layer. Some connectorless multicore rigid busbars, such as connectorless multicore rigid busbars internal to a battery pack, can be implemented without a shielding layer.

In some embodiments, the end of the connectorless multicore rigid busbar includes a groove. Any suitable insulating material can mate with the groove to provide high voltage creepage and clearance isolation between rigid conductors in the rigid multicore busbar. For example, the groove cover can be made by using an insulating plastic. A groove cover can mate (or be fitted) with the groove. The groove can contribute to high voltage isolation. The groove cover can provide an opening to mate with a groove cover to provide high voltage creepage and clearance isolation.

In some embodiments, the connectorless multicore rigid busbar includes a surrounding assembly. The surrounding assembly may include a locking mechanism. For example, the connectorless multicore rigid busbar can include one or more locking holes on the surrounding assembly (e.g., the body of the connectorless multicore rigid busbar). The one or more locking holes on the surrounding assembly can mate with a locking mechanism. For example, a locking piece can be inserted into the locking hole to hold the connectorless multicore rigid busbar within the vehicle. The locking piece can prevent movement and fretting of the electrical contact. The electrical contact can be exposed ends of the connectorless multicore rigid busbar. In some embodiments, other methods, such as using a larger (e.g., oversized) bracket that holds the connectorless multicore rigid busbar, can be utilized to prevent the movement and fretting of the electrical contact.

The body of the connectorless multicore rigid busbar can be symmetrically bent. A symmetric bending technique can elongate and shift the rigid conductors by even amounts. Thus, the bent connectorless multicore rigid busbar can have even lengths of the rigid conductors. In some embodiments, the rigid conductors can be cut at the ends of the connectorless multicore rigid busbar after bending to make even lengths of the rigid conductors. In some embodiments, after bending the connectorless multicore rigid busbar, the uneven conductors at the end of the connectorless multicore rigid busbar can be elongated to make an even length with other rigid conductors. For example, the uneven conductors at the end of the connectorless multicore rigid busbar can be pulled to make the even length conductors after bending the connectorless multicore rigid busbar.

Various cross-sectional shapes of the connectorless multicore rigid busbar can enhance and/or optimize the electrical connection and power distribution within a power distribution system, such as a power distribution system of a vehicle. In one embodiment, the rigid conductors have a circular cross-section, where the rigid conductors are surrounded by an insulator. In some embodiments, the rigid conductors have a rectangular cross-section, where the rigid conductors are surrounded by insulator. Any suitable combination of features of the various cross-sectional shapes of the connectorless multicore rigid busbars disclosed herein can be implemented together with each other.

Various numbers of the rigid conductors can enhance and/or optimize an electrical connection packaging, such as an electric connection packaging for a vehicle. The numbers of rigid conductors can be even, and each pair of the rigid conductors can be connected to an electrical component. Alternatively, a number of rigid conductors can be odd. In one example, with an odd number of rigid conductors, one of the rigid conductors can be connected to a negative terminal (e.g., a ground terminal) of a vehicle, and the other rigid conductors can be connected to the corresponding positive terminal of an electrical component. The electrical component's negative terminal can be connected to the rigid conductor that is connected to the vehicle's negative terminal. Although embodiments may be discussed with the connectorless multicore rigid busbar having four or five rigid conductors, any suitable principles and advantages disclosed herein can be applied to multicore busbars with any other suitable number of rigid conductors.

An electrical insulator of the multicore busbar may be made of any electrically insulating material, such as cross-linked polyethylene (XLPE), PVC, silicone, or plastic.

The connectorless multicore rigid busbar can include a variety of different cross-section areas of the rigid conductors for particular applications. For example, one of the rigid conductors can have a larger cross-section area than other rigid conductors within the connectorless multicore rigid busbar. Although embodiments may be discussed with the connectorless multicore rigid busbar having circular or rectangular cross-section area for illustrative purposes, any suitable principles and advantages disclosed herein can be applied to applications with any other suitable cross-sectional areas.

The technology disclosed herein can be applied to a variety of applications. For example, in addition to using the connectorless multicore rigid busbar to distribute power or connect electrical components, a connectorless multicore rigid busbar can charge the battery pack transferring electric power from the vehicle's charging inlet to a battery pack. The busbars disclosed herein can be used in vehicles or in any other suitable system with power distribution.

In certain embodiments, a connectorless multicore rigid busbar can be used in an electric vehicle. The electric vehicle can be a car, a sport utility vehicle, a truck, or any other electric vehicle. With implementing the connectorless multicore rigid busbar, each end of the connectorless multicore rigid busbar can be directly connected to one or more electrical joints. Thus, since each end of the connectorless multicore rigid busbar can be directly connected (e.g., directly mated) to electrical joints, implementing the connectorless multicore rigid busbar may not involve electrical connector assembly parts, such as electrical terminals, seals, insulation plastics, shields, or housing units to connect or be connected to the electrical joint. Assembly of an electrical power distribution system can be easier with the connectorless multicore rigid busbar in a factory assembly environment relative to flexible harness assemblies. The connectorless multicore rigid busbar can carry direct current (DC), alternating current (AC), or AC and DC. Raw material for the connectorless multicore rigid busbar can be densely packed and shipped directly from a supplier to the site of installation to bend to conform to in-vehicle packaging. Accordingly, the processing of cables and connectors is not needed.

In some applications, a battery pack of an electric vehicle includes one or more electrical joints. One end of the connectorless multicore rigid busbar can be connected to the battery pack through the electrical joint. Another end of the connectorless multicore rigid busbar can be connected to one or more other electrical components of the electric vehicle. Electrical power can be distributed to the other electrical component(s) through the connectorless multicore rigid busbars. The length and route of the connectorless multicore rigid busbar may be determined based on the vehicle's packaging constraints and location of the electrical power source, such as the battery pack, and load, such as any electrical components within the electric vehicle.

To simplify the discussion and not to limit the present disclosure, Figures, as disclosed herein, include certain shapes of connectorless multicore rigid busbar and numbers of rigid conductors. However, these certain shapes of the connectorless multicore rigid busbar and the number of rigid conductors implemented in the connectorless multicore rigid busbar are merely provided as examples. Thus, the present disclosure does not limit the shape and number of the connectorless multicore rigid busbar.

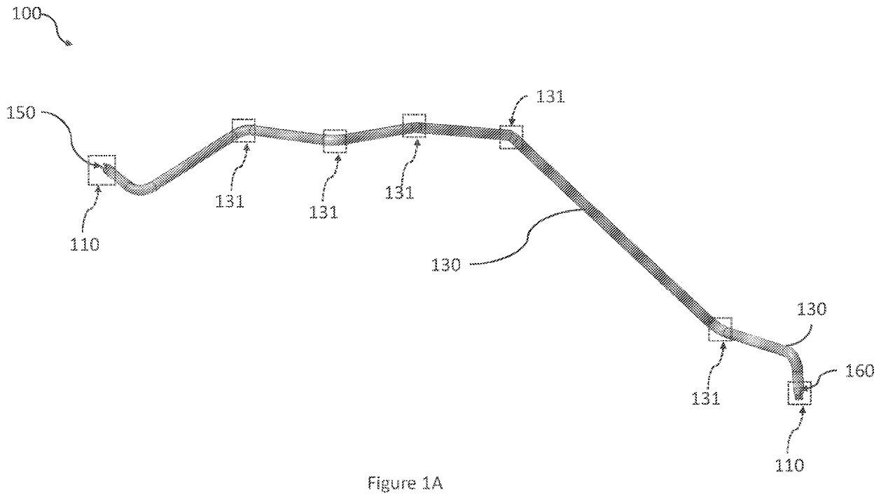

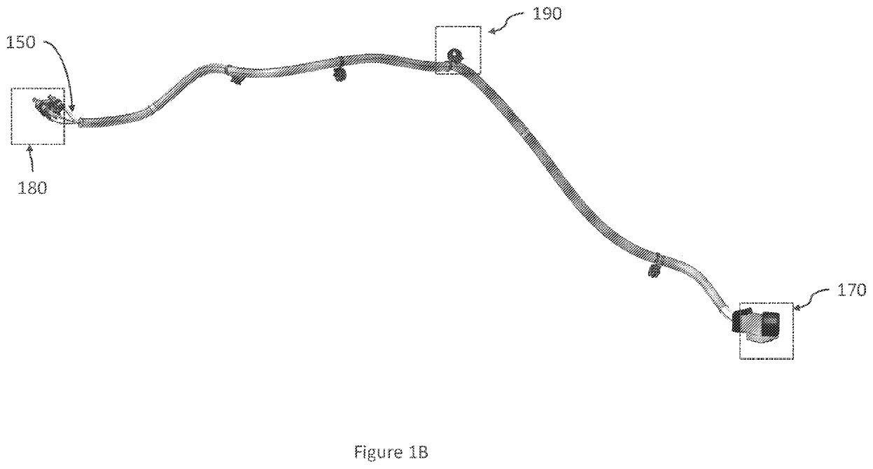

FIG. 1A depicts a connectorless multicore rigid busbar 100. The connectorless multicore rigid busbar 100 is rigid and retains its shape. As illustrated, the connectorless multicore rigid busbar 100 includes ends 110 and a body 130. In some embodiments, one end 110 of the rigid busbar 100 can be a source end 150, and another end 110 of the rigid busbar 100 can be a load end 160. The end 110 of the rigid busbar 100 can be directly connected to an electrical terminal of a component without using a connector. For example, the ends of the rigid busbar 100 can be directly connected to the electrical terminal without an additional blade or pin. In some embodiments, where the connectorless multicore rigid busbar 100 is used to distribute power from the battery pack, the source end 150 can be connected to the battery pack, and the load end 160 can be connected to an electrical component. For example, the source end 150 can be positioned in one direction toward the electrical power source. The load end 160 can be positioned in the opposite direction toward the load or electrical component, respectively. In some embodiments, where the connectorless multicore rigid busbar 100 is used to electrically connect two or more electrical components, the source end 150 is connected to an electrical component, and the load end 160 is connected to another electrical component, so the two electrical components are electrically coupled. As shown in FIG. 1A, the connectorless multicore rigid busbar 100 can include a body 130. The body 130 can include one or more bending points 131. The bending points 131 and the bending shape may be selected based on the vehicle's packaging constraints and the location of the electrical power source and/or electrical components.

FIG. 1B depicts a braided harness assembly. As illustrated, the flexible braided harness assembly utilizes one or more stranded cables as the electrical pathway, and these stranded cables are tied using ties 190 and tape to assemble the cables. Furthermore, the flexible braided harness assembly includes end connectors 170, 180. The end connectors 170 and 180 may include electrical terminals connected to the end of the cables that can mate with other electrical components. The flexible braided cable assembly process can carry relatively high assembly costs and vehicle packaging constraints.

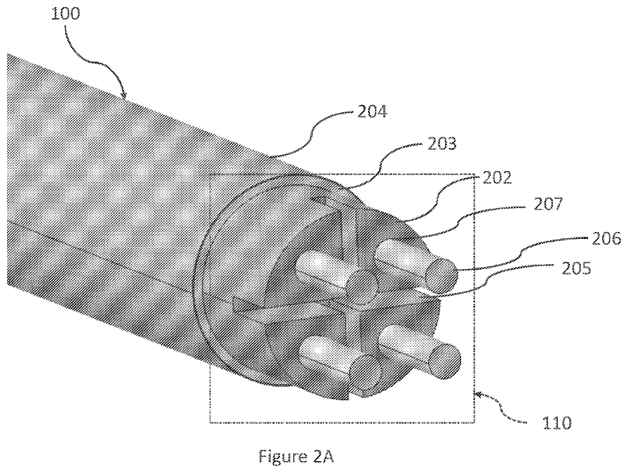

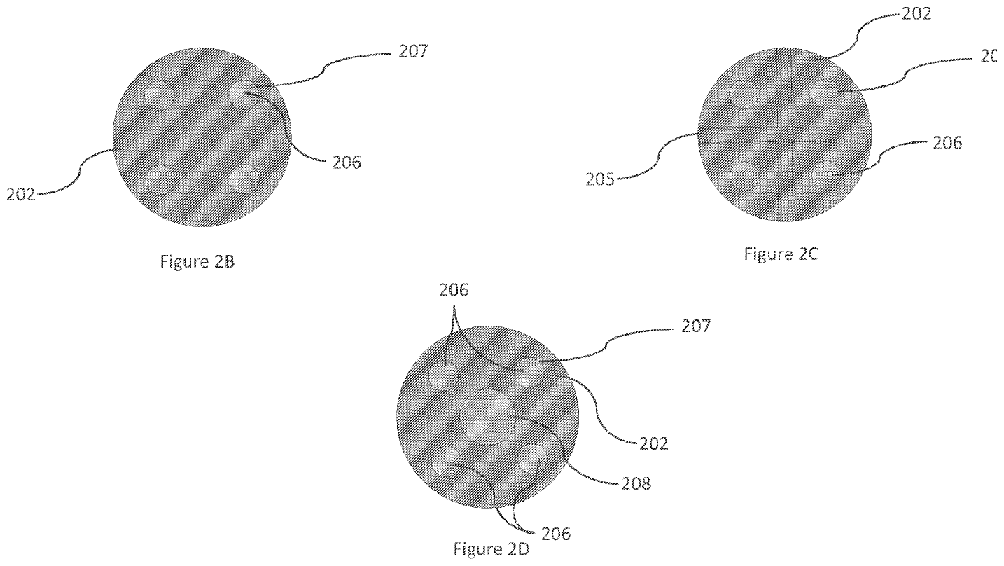

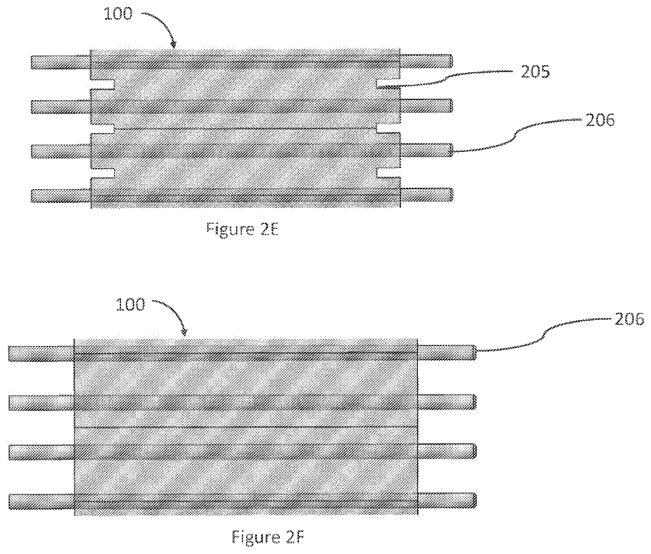

FIG. 2A depicts one of the two ends 110 of the connectorless multicore rigid busbar 100. As illustrated, the end 110 of the connectorless multicore rigid busbar 100 can include one or more rigid conductors 206. The rigid conductors (shown in FIG. 2B-2D) inside the electrical insulator 202 extend at both ends 110, forming rigid conductor 206. The rigid conductor 206 can function as an electrical joint terminal because it can form a rigid surface for an electrical connection. The rigid conductor 206 at both ends 110 of the connectorless multicore rigid busbar 100 can be coupled with proper positive and negative terminals in the electrical components or battery packs in the vehicle. Any suitable end-connection unit for transferring power can be in various applications.

In some embodiments, for example, as shown in FIGS. 2A-2F, the connectorless multicore rigid busbar 100 can include a plurality of rigid conductors 206 surrounded by an electrical insulator 202. The rigid multicore busbar 100 further comprises the electrical insulator 202, whereas the electrical insulator 202 comprises hollow portions 207. As shown in FIGS. 2A-2D, each of the rigid conductors 206 is fitted inside a respective hollow portion 207 of the electrical insulator 202. The rigid conductor 206 may be made of any suitable conductive material, such as aluminum, copper, bronze, brass, gold, silver, the like, or any suitable combination or alloy thereof. The electrical insulator 202 may be made of any suitable electrically insulating material, such as XLPE, PVC, nylon, silicone, or plastic. The electrical insulator 202 can be molded through injection molding or extrusion processes.

In some embodiments, for example, as shown in FIGS. 2A and 2C, each end 110 of the connectorless multicore rigid busbar 100 can include a groove 205. The groove 205 can mate with a groove cover (or other insulating material over the groove) to thereby provide a proper distance for high voltage creepage and clearance isolation. The groove 205 can be molded or machined at the ends 110 of the connectorless multicore rigid busbar 100.

In some embodiments, for example, as shown in FIG. 2A, the electrical insulator 202 is surrounded by a shielding layer 203. The shielding layer 203 provides a shield against electromagnetic interference. Such shielding can protect from damage. The shielding layer 203 may be flexible or solid. The shielding layer 203 can be made of any EMI shielding material, such as aluminum. In some embodiments, the shielding layer 203 can provide physical protection for the insulation layer from an external condition and/or damage during a manufacturing process, such as a 3-dimensional bending process. In some embodiments, the shielding layer 203 may be grounded to the vehicle's Body in White (BIW). This can provide an isolation loss detection in the event of a high voltage short circuit. In some embodiments, the shielding layer 203 is surrounded by a coloring layer 204. The coloring layer 204 may be made with any suitable color coating.

FIGS. 2B-2D depict a cross-sectional views of various embodiments of the connectorless multicore rigid busbar 100. As shown in FIG. 2B, the connectorless multicore rigid busbar 100 can comprise four rigid conductors 206. As shown in FIG. 2C, the connectorless multicore rigid busbar 100 can comprise four rigid conductors 206 and the groove 205 in the electrical insulator 202. The groove 205 can be located at the end of a connectorless multicore rigid busbar. As shown in FIG. 2D, the connectorless multicore rigid busbar 100 comprises an odd number of rigid conductors 206 and 208. In such embodiments, a particular rigid conductor 208 can function as a ground terminal, where the rigid conductor 208 is connected to the ground terminal of the vehicle. Other rigid conductors 206 can be connected to a positive terminal of each corresponding electrical component within the vehicle. Connectorless multicore rigid busbars in accordance with any suitable principles and advantages disclosed herein, can have any suitable number of rigid conductors.

FIGS. 2E and 2F depict embodiments of the connectorless multicore rigid busbar 100 having a rectangular shape. For example, the connectorless multicore rigid busbar 100 can be packaged in a rectangular shape having the rigid conductors 206 implemented in an array. As illustrated in FIGS. 2E and 2F, four rigid conductors 206 can be implemented in a row. The cross-sectional shape of the connectorless multicore rigid busbar 100 can be rectangular. FIG. 2E depicts four rigid conductors 206 implemented in the connectorless multicore rigid busbar 100. As illustrated in FIG. 2E, the connectorless multicore rigid busbar 100 can include four rigid conductors 206 arranged in a row. The connectorless multicore rigid busbar 100 can also include grooves 205 at its ends. In some examples, for example, as depicted in FIG. 2F, the connectorless multicore rigid busbar 100 may not include grooves between the ends of rigid conductors 206.

Connectorless multicore rigid busbars disclosed herein can be connected to various connection units. The connectorless multicore rigid busbars disclosed herein can be compatible with connection units for other busbars in certain applications. Accordingly, the connectorless multicore rigid busbars disclosed herein can have compatibility with various connection units and electrical components within the vehicle.

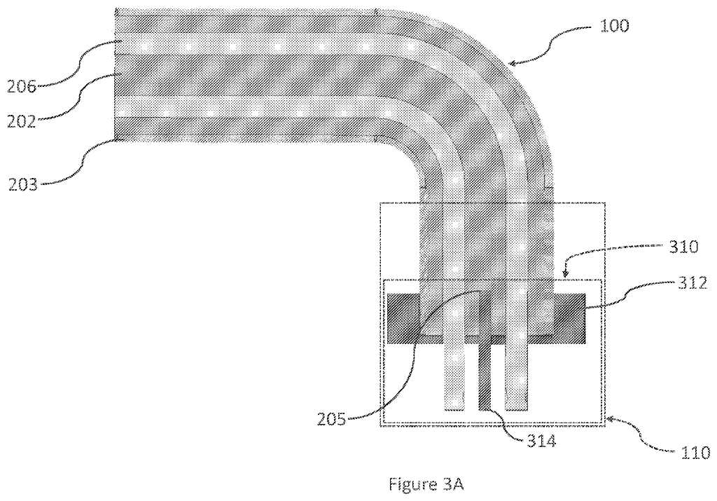

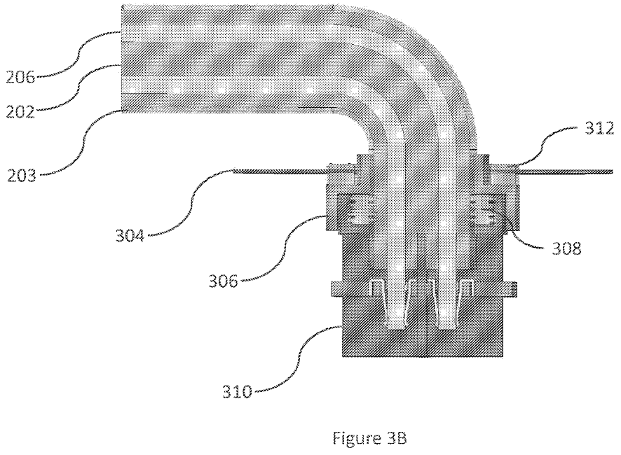

FIG. 3A depicts one end 110 of the connectorless multicore rigid busbar 100, including a groove cover 310 that interfaces with a groove 205 to provide high voltage creepage and clearance isolation. The groove cover 310 may be inserted into the groove 205. The groove cover 310 can provide high voltage creepage and clearance isolation. The groove cover 310 can be made of any suitable electrically insulating material, such as XLPE, PVC, nylon, silicone, or plastic. Grooves and corresponding groove covers can have any suitable structure for a particular application. In some embodiments, the groove cover 310 can include groove cover top portion 312 and groove cover extension 314. The groove cover top portion 312 may be plugged into the groove 205 to provide high voltage creepage and clearance isolation at the end 110 of the connectorless multicore rigid busbar 100. The groove cover extension 314 can be used to provide the high voltage creepage and clearance isolation when the end 110 of the connectorless multicore rigid busbar 100 is mated with electrical joints of an electrical component. For example, each rigid conductors 206 and the groove cover extension 314 can be plugged into a corresponding electrical joint of the electrical component, and the groove cover extension 314 can provide high voltage creepage and clearance isolation between the electrical joint.

FIG. 3B depicts one end 110 of the connectorless multicore rigid busbar 100, including a groove cover 310 that interfaces with a groove 205 to provide high voltage creepage and clearance isolation. In FIG. 3B, a seal 308 can seal an outer diameter of the connectorless multicore rigid busbar 100. In some embodiments, the end 110 of the connectorless multicore rigid busbar 100 can be assembled as shown in FIG. 3B. For examples, the end 110 of the connectorless multicore rigid busbar 100 can be assembled with an enclosure 304 that the end 110 of the connectorless multicore rigid busbar 100 plugs into. In some examples, the enclosure 304 can be a battery pack enclosure. The end 110 of the connectorless multicore rigid busbar 100 can be assembled with a header assembly plastic 306, header assembly seal 308 that interfaces against the outside diameter of the connectorless multicore rigid busbar 100, groove cover (e.g., header assembly groove cover) 310 that holds the seal and provide high voltage creepage and clearance isolation, and header to enclosure seal 312.

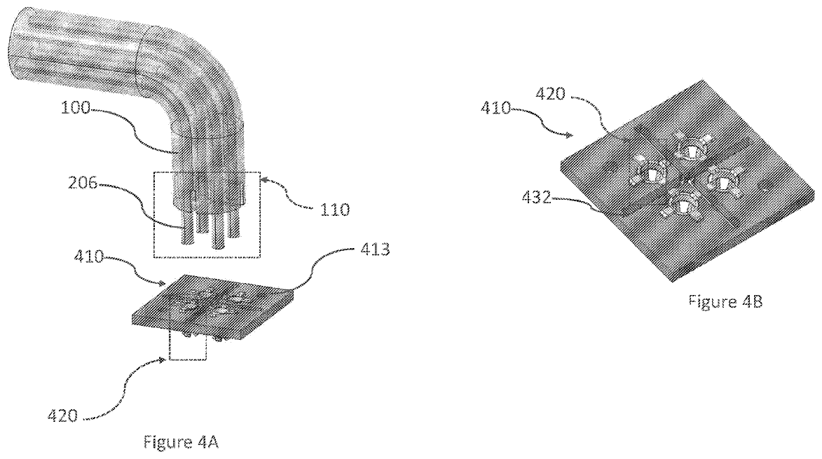

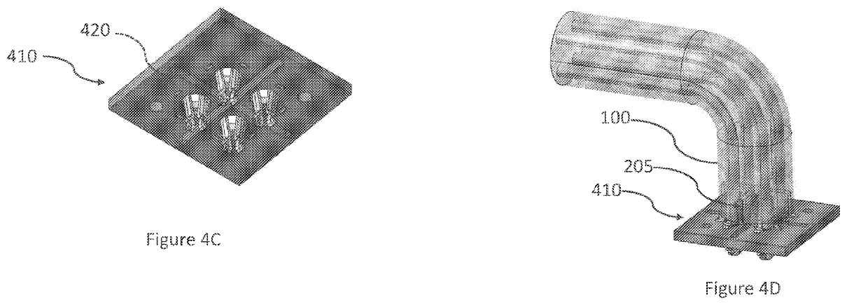

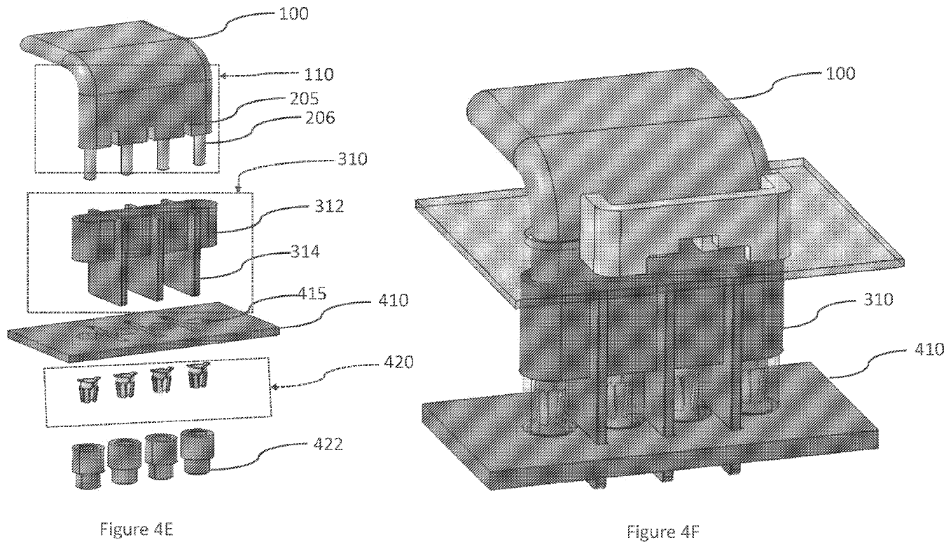

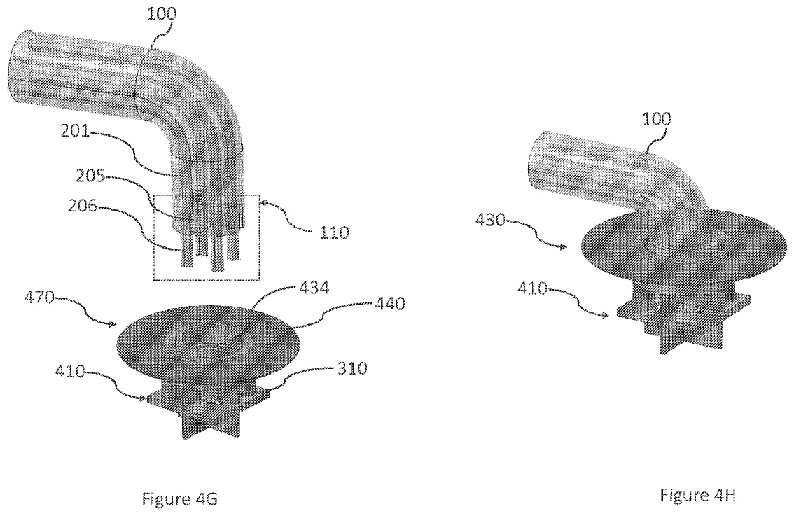

FIGS. 4A-4H depict various terminals that can be connected to the ends 110 of the connectorless multicore rigid busbar 100.

FIG. 4A depicts electrical terminals 420 mounted on a printed circuit board assembly (PCBA) 410 that can be connected to the end 110 of the connectorless multicore rigid busbar 100. The electrical terminal 420 can be inserted into the PCBA 410. The electrical terminal 420 can be implemented by sockets. In some embodiments, the rigid conductor 206 at the end 110 of the connectorless multicore rigid busbar 100 can be plugged into the electrical terminals 420. For example, the rigid conductor 206 can be plugged into the corresponding electrical terminal 420.

FIG. 4B depicts a top view of the PCBA 410. In some embodiments, each rigid conductor 206 is plugged into a corresponding electrical terminal 420. The PCBA 410 can also include a groove cover portion 432. For example, a groove cover extension 314 of the groove cover 310 can be inserted into the groove cover portion 432 to isolate between each electrical terminal 420.

FIG. 4C depicts a bottom view of the PCBA 410. The electrical terminal 420 can be inserted into the rigid conductor hollow portion 415 of the PCBA 410. In some embodiments, the rigid conductor 206 can be plugged into the electrical terminal 420. In some embodiments, the electrical terminal 420 can be mated with the corresponding terminal in another electrical component via the electrical terminal 420 at the bottom of the PCBA 410. For example, the connectorless multicore rigid busbar 100 may distribute electrical power to the electrical components integrated into the PCBA 410. Further, in this example, the connectorless multicore rigid busbar 100 may further distribute the electrical power to one or more other electrical components by the electrical terminal(s) of the one or more electrical components. In some other embodiments, the bottom of the electrical terminal 420 (e.g., the electrical terminal at the bottom of the PCBA 410) can be electrically isolated by using electrical terminal covers. For example, the connectorless multicore rigid busbar 100 may distribute the electrical power to the electrical components integrated into the PCBA 410.

The other end of the connectorless multicore rigid busbar 100 can be connected to another PCBA 410, similar to as shown for the end 110. Both ends of a multicore rigid busbar 100 can be similarly connected to respective PCBA 410 in certain applications. One of the ends of a multicore ridged busbar 100 can be connected to a PCBA 410, and the other end can be connected to a different type of connection unit in some other applications.

FIG. 4D depicts an example embodiment of the PCBA 410 connected at the end 110 of the connectorless multicore rigid busbar 100. In some embodiments, a groove cover top portion 312 of the groove cover 310 is inserted into the groove 205. The groove cover 310 can provide high voltage creepage and clearance isolation between the rigid conductors 206. After inserting the groove cover top portion 312 into the groove 205, the PCBA 410 can be inserted into the groove cover extension 314 of the groove cover 310. For example, the groove cover extension 314 can pass through the groove cover portion 432 of the PCBA 410. The rigid conductor 206 also can pass through the PCBA electrical terminal 420 of the PCBA 410. The groove cover extension 314 can provide high voltage creepage and clearance isolation between the electrical terminals 420 of the PCBA 410.

FIG. 4E depicts an example assembly of the connectorless multicore rigid busbar 100 and the PCBA 410. As shown in FIG. 4E, an end 110 of the connectorless multicore rigid busbar 100 can be assembled with the PCBA 410 by using the groove cover 310, electrical terminals 420, and electrical terminal holder 422. In some embodiments, the electrical terminal holder 422 may hold the corresponding electrical terminal 420. In other embodiments, the electrical terminals 420 can adhere to the PCBA 410, such as by soldering, gluing by using epoxy, etc. In some embodiments, the groove cover top portion 312 of the groove cover 310 can be plugged into the groove 205. The groove cover top portion 312 may provide high voltage creepage and clearance isolation at the end 110 of the connectorless multicore rigid busbar 100. In some embodiments, the electrical terminals 420 can be inserted into the PCBA 410 via the rigid conductor hollow portion 415 of the PCBA 410. After plugging the electrical terminal 420 into the corresponding rigid conductor hollow portion 415, the top of the electrical terminal 420 can be located at the top of the PCBA 410, and the bottom of the electrical terminal 420 can be located at the bottom of the PCBA 410. In some embodiments, the rigid conductor 206 at the end 110 of the connectorless multicore rigid busbar 100 can be plugged into the electrical terminals 420. For example, the rigid conductor 206 can be plugged into the corresponding electrical terminal 420. The rigid conductors 206 may be plugged into the electrical terminal 420. terminal holder 422 The electrical terminal 420 can be connected to the rigid conductor 206. By utilizing the electrical terminal 420, the rigid conductor 206 can be directly connected to the PCBA 410. In some embodiments, the electrical terminal 420 can be implemented inside the electrical terminal holder 422, where the electrical terminal holder 422 is plugged into the rigid conductor hollow portion 415.

FIG. 4F depicts an assembled connectorless multicore rigid busbar 100 with the PCBA 410. In some embodiments, the PCBA 410 may include integrated electrical components. The PCBA 410, as assembled with the connectorless multicore rigid busbar 100, may receive electrical power from the power source via the rigid conductors 206.

FIGS. 4G and 4H depict a header assembly 470 that the end 110 of the connectorless multicore rigid busbar can plug into. In some embodiments, for example, as shown in FIG. 4E, the header assembly 470 may include the PCBA 410, the groove cover 310, and a header assembly within an enclosure 440. In such embodiments, the rigid conductor 206 at the end 110 of the connectorless multicore rigid busbar 100 can be plugged into the electrical terminals within the PCBA 410 (the electrical terminals are not shown in FIG. 4C). In some embodiments, for example as shown in FIG. 4F, the groove cover 310 is fitted into the groove 205. The groove cover 310 can provide high voltage creepage and clearance isolation. In such embodiments, the header assembly includes the enclosure 440. The enclosure 440 can be a stamped metal enclosure. In some embodiments, a seal 434 can seal an outer diameter of the end 110 of the connectorless multicore rigid busbar 100.

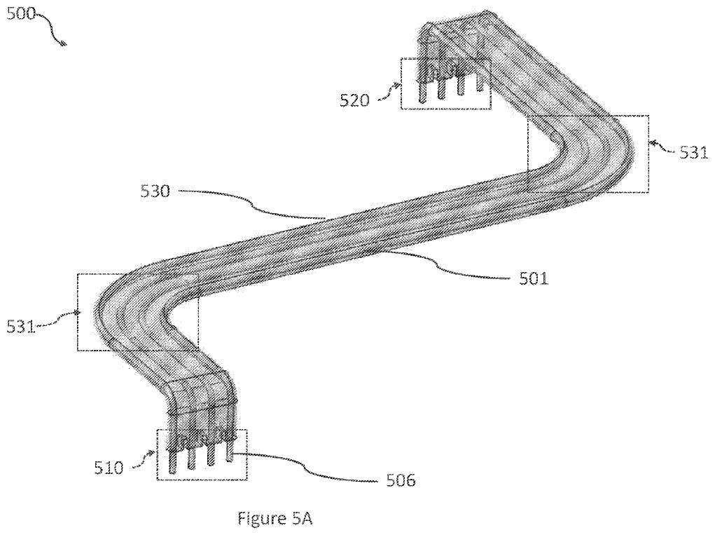

FIG. 5A illustrates a connectorless multicore rigid busbar 500 according to an embodiment, where the busbar 500 is bent to conforming to vehicle packaging requirements. The connectorless multicore rigid busbar 500 has a generally rectangular shape. As illustrated, the connectorless multicore rigid busbar 500 includes two ends 510, and a body 530. FIG. 5A illustrates a rigid conductor 506 of one end 510 of the connectorless multicore rigid busbar. In some embodiments, where the connectorless multicore rigid busbar 500 is used to distribute power from the battery pack, the one end 510 can be connected to the battery pack and another end 510 can be connected to an electrical component. In some embodiments, as shown in Figure SA, where the connectorless multicore rigid busbar 500 is used to electrically connect two or more electrical components, the one end 510 is connected to an electrical component, and the other end 510 is connected to another electrical component, so the two electrical components are electrically coupled. As shown in FIG. 5A, the body 530 comprises bending points 531. The bending points 531 and the bending shape may be selected based on the vehicle's packaging constraints and the location of the electrical power source and/or electrical components.

FIG. 5B depicts the one end 510 of the connectorless multicore rigid busbar 500. The other end 520 of the connectorless multicore rigid busbar 500 can be implemented in accordance with any suitable principles and advantages discussed with reference to the end 510. The end 510 of the connectorless multicore rigid busbar 500 includes rigid conductor 506. The rigid conductor 506 functions as an electrical joint terminal. The rigid conductor 506 can be coupled with proper positive and negative terminals in the vehicle's electrical components or battery packs. Any suitable end-connection unit for transferring power can be implemented in various applications.

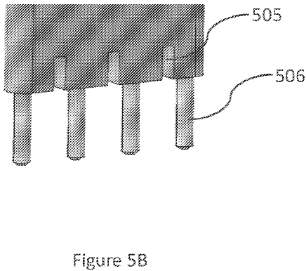

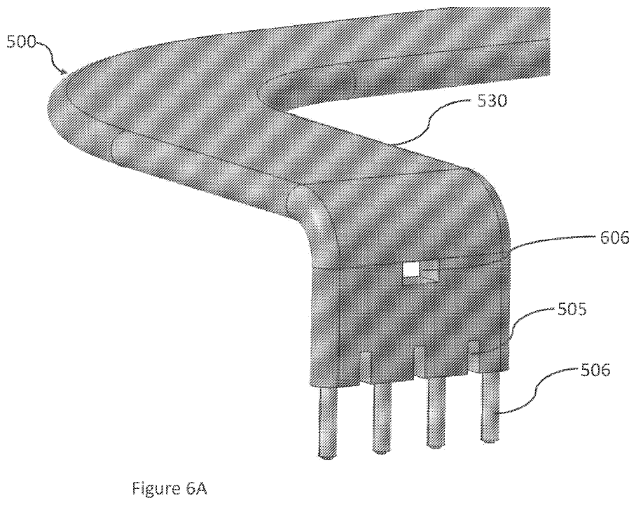

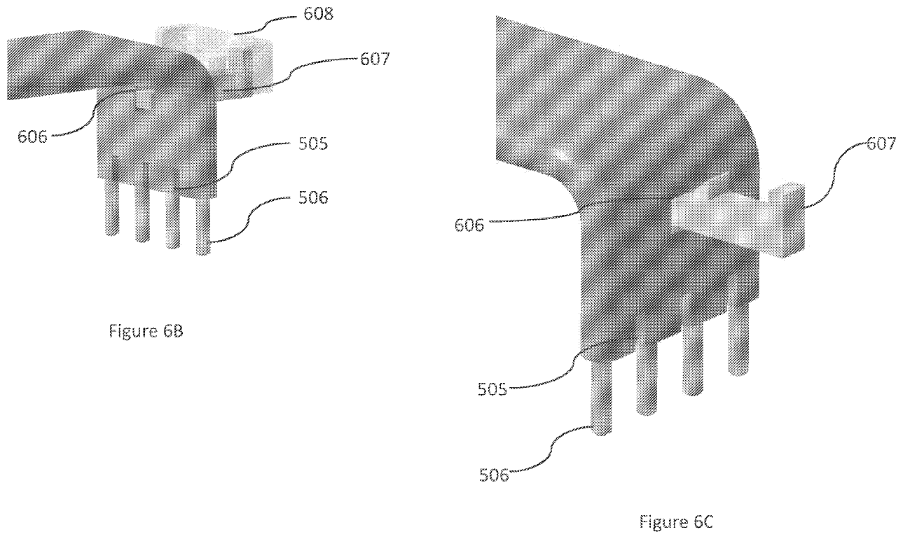

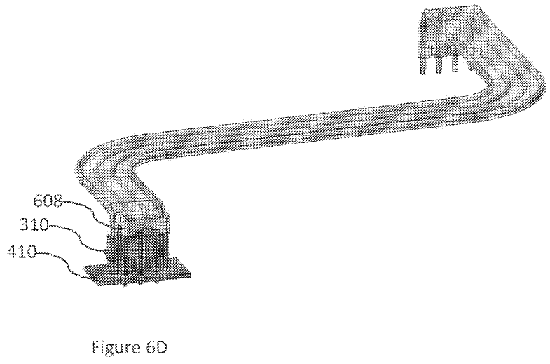

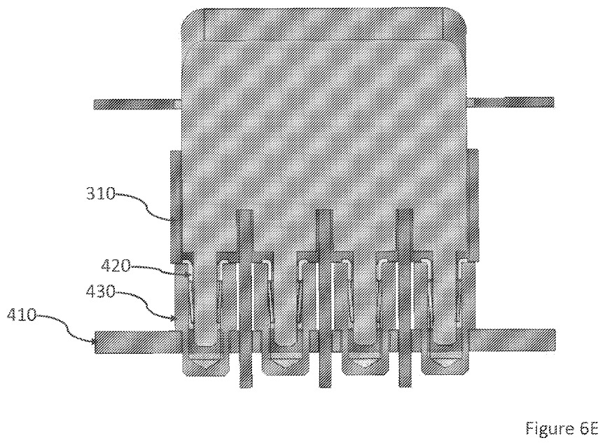

FIGS. 6A-6C illustrate a connectorless multicore rigid busbar 500, including a locking mechanism to set the busbar position and prevent electrical contact fretting. In the connectorless multicore rigid busbar 500 of FIG. 6A, the body 530 comprises a locking hole 606. FIGS. 6B and 6C show that a surrounding assembly, including a locking piece 607 may be inserted into the locking hole 606. The connectorless multicore rigid busbar 500 may be fixed within the vehicle by using the locking piece 607 and locking hole 606. For example, as shown in FIG. 6B, one end of the locking piece 607 is inserted into the locking hole 606, and another end of the locking piece 607 is assembled into a surrounding assembly 608. This locking mechanism can fix the position of the connectorless multicore rigid busbar 500 relatives to the surrounding assembly 608. With a locking mechanism, the connectorless multicore rigid busbar 500 can be secured in place to reduce or prevent electrical connection fretting or movement under vehicle vibration and/or motion.

FIGS. 6D and 6E depict an example embodiment of the connectorless multicore rigid busbar 100. FIG. 6D depicts the connectorless multicore rigid busbar 100 assembled with the locking piece (not shown in FIG. 6D), the PCBA 410, the groove cover 310, the terminal holder 422, and the surrounding assembly 608. FIG. 6E depicts the connectorless multicore rigid busbar 100 assembled with the groove cover 310, the electrical terminals 420, the electrical terminal holder 422, and the PCBA 410.

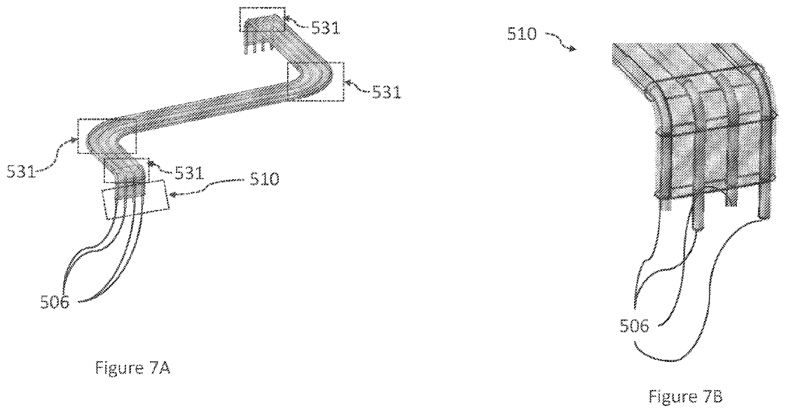

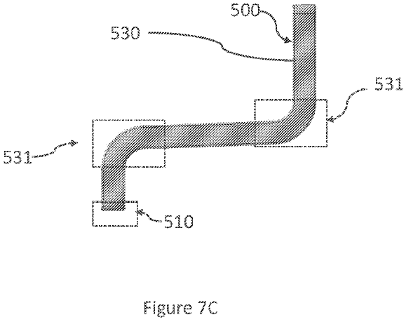

FIGS. 7A and 7B depict the connectorless multicore rigid busbar 500 with uneven rigid conductors 501 at one end 510, where the busbar is bent to conform to vehicle packaging requirements. The uneven rigid conductor 506 can be due to the connectorless multicore rigid busbar's 500 bending points 531. The rigid conductors inside the connectorless multicore rigid busbar 500 can be elongated and shifted at different rates based on distance to the bending axis centerline of the connectorless multicore rigid busbar 600. Thus, the rigid conductor 506 at one end 510 of the connectorless multicore rigid busbar 500 can have uneven lengths.

FIG. 7C depicts an embodiment of the connectorless multicore rigid busbar 500 to mitigate or prevent connectorless multicore rigid busbar 500 from having the uneven rigid conductor lengths at one end 510. As shown in FIG. 7C, the connectorless multicore rigid busbar 500 is symmetrically bent at bending points 531. Thus, the rigid conductors inside the connectorless multicore rigid busbar 500 can be approximately equally elongated and shifted. Therefore, the rigid conductors have the same general lengths at the ends of the connectorless multicore rigid busbar 500.

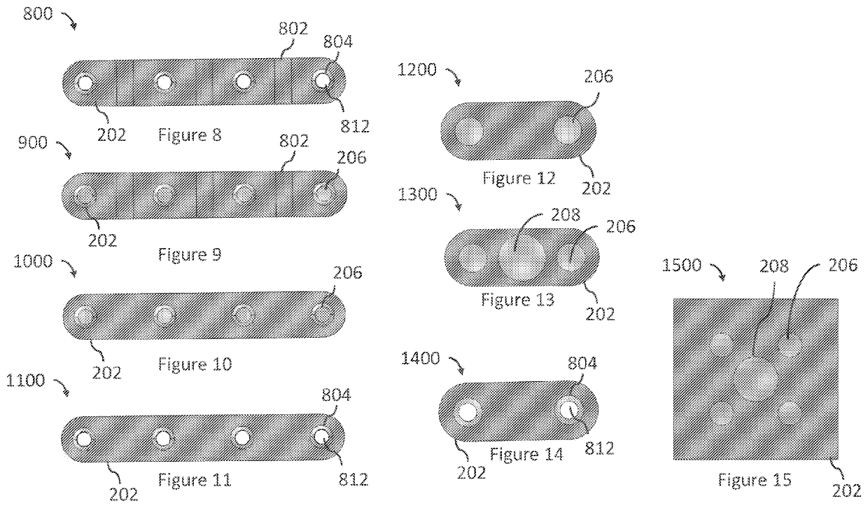

FIGS. 8 to 15 illustrate cross-sectional view of connectorless multicore rigid busbars. Any suitable principles and advantages of these connectorless multicore rigid busbars can be implemented together with each other. Any suitable principles and advantages of these connectorless multicore rigid busbars can be implemented any other suitable principles and advantages disclosed herein.

FIG. 8 illustrates a cross-sectional view of a connectorless multicore rigid busbar 800 according to an embodiment. The connectorless multicore rigid busbar 800 has a generally rectangular shaped cross-section and includes three grooves 802 and four circular rigid conductors 804, where there is a hollow portion 812 within each rigid conductor 804. The grooves 802 can be located in an end portion of the connectorless multicore rigid busbar 800. The connectorless multicore rigid busbar 800 has rounded sides. In some embodiments, the hollow portion 812 can be used for cooling. For example, air can flow through the hollow portion 812 to cool down the heat generated from the rigid conductor 804 during power distribution. In some embodiments, liquid coolant can flow through the hollow portion 812.

FIG. 9 illustrates a cross-sectional view of a connectorless multicore rigid busbar 900 according to an embodiment. The connectorless multicore rigid busbar 900 has a generally rectangular shaped cross-section and includes three grooves 802 and four circular rigid conductors 206 surrounded by an electrical insulator 202.

FIG. 10 illustrates a cross-sectional view of a connectorless multicore rigid busbar 1000 according to an embodiment. The connectorless multicore rigid busbar 1000 is like the connectorless multicore rigid busbar 900 of FIG. 9, except that there are no grooves.

FIG. 11 illustrates a cross-sectional view of a connectorless multicore rigid busbar 1100 according to an embodiment. The connectorless multicore rigid busbar 1100 is like the connectorless multicore rigid busbar 800 of FIG. 8, except that there are no grooves.

FIG. 12 illustrates a cross-sectional view of a connectorless multicore rigid busbar 1200 according to an embodiment. The connectorless multicore rigid busbar 1200 has a generally rectangular shaped cross-section and includes two circular rigid conductors 206.

FIG. 13 illustrates a cross-sectional view of a connectorless multicore rigid busbar 1300 according to an embodiment. The connectorless multicore rigid busbar has a generally rectangular shaped cross-section and includes three circular rigid conductors 206 and 208, where the center rigid conductor 208 has a larger cross-section area than other rigid conductors 206. The center rigid conductor 208 can be grounded.

FIG. 14 illustrates a cross-sectional view of a connectorless multicore rigid busbar 1400 according to an embodiment. The connectorless multicore rigid busbar 1400 has a generally rectangular shaped cross-section and includes two circular rigid conductors 804, where there is a hollow portion 812 within each rigid conductor 804.

FIG. 15 illustrates a connectorless multicore rigid busbar 1500 according to an embodiment. The connectorless multicore rigid busbar 1500 is a rectangular shape busbar and includes five circular rigid conductors 206 and 208, wherein the center rigid conductor 208 has a larger cross-section area than other rigid conductors 206.

Unless the context clearly requires otherwise, throughout the description and the claims, the words “comprise,” “comprising,” “include,” “including” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “may,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments.

The foregoing description has been described with reference to specific embodiments. However, the illustrative discussions above are not intended to be exhaustive or to limit the inventions to the precise forms described. Many modifications and variations are possible in view of the above teachings. Others skilled in the art are thereby enabled to best utilize the techniques and various embodiments with various modifications as suited to various uses.

Although the disclosure and examples have been described with reference to the accompanying drawings, various changes and modifications will become apparent to those skilled in the art. Such changes and modifications are to be understood as being included within the scope of the disclosure.

1. A multicore rigid busbar comprising:
a plurality of rigid conductors configured to carry current between components; and
an insulator around the plurality of rigid conductors.

2. The multicore rigid busbar of claim 1, wherein an end of at least one of the rigid conductors is configured to directly connect to an electrical terminal.

3. The multicore rigid busbar of claim 1, wherein the rigid conductors comprise at least one of aluminum or copper.

4. The multicore rigid busbar of claim 1, wherein the insulator comprises at least one of cross-linked polyethylene (XLPE), polyvinyl chloride (PVC), nylon, silicone, thermoplastic, or thermoset plastic.

5. The multicore rigid busbar of claim 1, further comprising a load end and a source end that each have a rigid conductor.

6. The multicore rigid busbar of claim 4, wherein the rigid conductor at the source end is directly connectable to a battery pack.

7. The multicore rigid busbar of claim 4, wherein at least one of the rigid conductor is directly connectable to an electrical terminal on a printed circuit board assembly.

8. The multicore rigid busbar of claim 1, further comprising a shielding layer surrounding the insulator.

9. The multicore rigid busbar of claim 7, wherein the shielding layer is electrically conductive.

10. The multicore rigid busbar of claim 1, wherein the multicore rigid busbar is bent to conform to in-vehicle packaging and to extend between a vehicle battery pack and one or more electrical components.

11. The multicore rigid busbar of claim 1, wherein the multicore rigid busbar is shaped to conform to in-vehicle packaging and to extend between multiple of electrical components.

12. The multicore rigid busbar of claim 1, further comprising a groove located between rigid conductors of the plurality of rigid conductors.

13. The multicore rigid busbar of claim 1, further comprising a locking hole in a body of the multicore rigid busbar, the locking hole configured to receive a locking piece.

14. The multicore rigid busbar of claim 1, wherein the multicore rigid busbar is symmetrically bent.

15. The multicore rigid busbar of claim 14, wherein ends of the conductor have substantially the same length from cutting.

16. A vehicle comprising the multicore rigid busbar of claim 1.

17. The vehicle of claim 16, further comprising a battery pack connected to the multicore rigid busbar.

18. The vehicle of claim 16, wherein the vehicle is an electric vehicle.

19. An electrical connection system comprising:
a plurality of rigid conductors within a single outer sheathing;
an insulation layer around the plurality of rigid conductors, wherein the plurality of rigid conductors are configured to at least carry current from a source to a load, and wherein at least one of the plurality of rigid conductors is configured to directly connect to an electrical terminal.

20. The electrical connection system of claim 19, further comprising a shielding layer around the insulation layer.

21. (canceled)
